(19) United States
(12) Patent Application Publication
(10) Pub. No.: US 2006/0162865 A1
(43) Pub. Date: Jul. 27, 2006

(54) Apparatus for sealing envelopes of plastics material

(75) Inventor: Claus Karl Pfankuch, Hamburg (DE)

Correspondence Address: Friedrich Kueffner, Suite 910, 317 Madison Avenue, New York, NY, 10017, US

(73) Assignee: Pfankuch Maschinen GMbH

(21) Appl. No.: 10/627,349

(22) Filed: Jul. 24, 2003

(30) Foreign Application Priority Data
Aug. 7, 2002 (DE) 202 12 112.7

(51) Int. Cl. B32B 37/00

(52) U.S. Cl. 156/441.5; 156/379.6

(57) ABSTRACT

A device for sealing envelopes of plastics material, particularly polypropylene, includes a gluing station which, after filling of each envelope, applies an adhesive which can be activated or cured by light radiation onto at least one of the surfaces of the envelope to be glued. Following the gluing station in the conveying direction of the envelopes, a device for air radiation of the applied adhesive is provided.

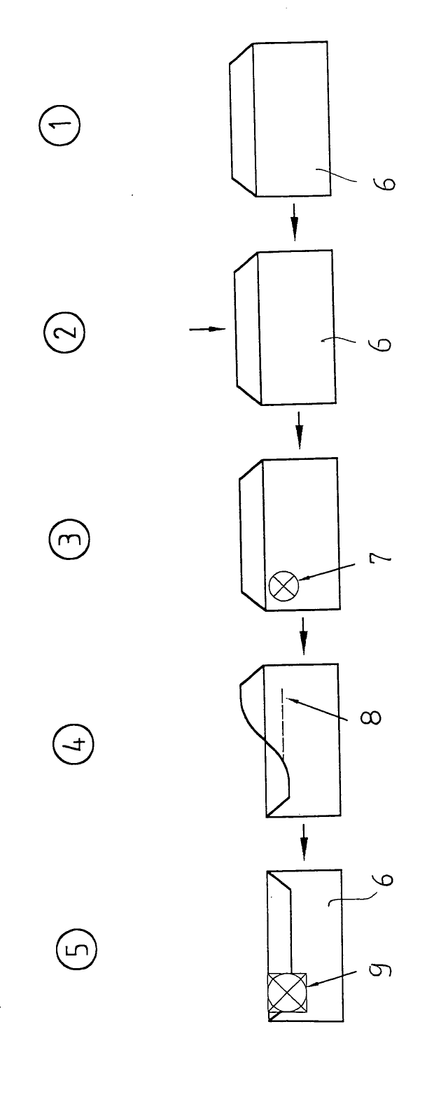

### BACKGROUND OF THE INVENTION

1. Field of the Invention

The present invention relates to an apparatus for sealing envelopes of plastics material, particularly polypropylene.

2. Description of the Related Art

In accordance with a known procedure, prefabricated envelopes of paper are automatically sealed during the mechanical filling of the envelopes by applying moisture to the water-soluble adhesive which has been applied during the manufacture of the envelope onto at least one of the surfaces to be glued. Subsequently, the envelope flap is folded over, so that gluing takes place. Any excess moisture must be removed from the paper. However, envelopes of plastics material, for example, polypropylene, could in the past only be securely sealed by a complicated hot-melt gluing process because a water-soluble adhesive could not be securely applied and does not provide a reliable sealed connection.

### SUMMARY OF THE INVENTION

Therefore, it is the primary object of the present invention to provide an apparatus of the above-described type which makes it possible to securely and quickly seal prefabricated envelopes of plastics material, wherein a manner of operation which is as simple and inexpensive as possible is to be achieved.

In accordance with the present invention, the apparatus for sealing envelops of plastics material, particularly polypropylene, includes a gluing station which, after each envelope has been filled, applies an adhesive which can be activated or cured by light radiation onto at least one of the surfaces of the envelope to be glued, and, following the gluing station in the conveying direction of the envelopes, a device for directing light radiation to the applied glue.

The apparatus according to the present invention operates with an adhesive which can be activated or cured by light radiation, wherein the adhesive is applied to at least one of the surfaces of the envelope to be glued, preferably the back side of the envelope. Subsequently, the envelope flap is folded over and the adhesive is activated or cured by light radiation.

In accordance with an advantageous embodiment, the adhesive can be cured by UV-radiation, wherein the adhesive is cured by a device for applying UV-radiation.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

The single figure of the drawing schematically illustrates the sequence of filling and sealing an envelope in an apparatus according to the present invention.

### DETAILED DESCRIPTION OF THE INVENTION

Altogether five positions are illustrated in the drawing:
1. Feeding;
2. Filling;
3. Application of adhesive;
4. Closing;
5. Adhesive activation.

A prefabricated envelope 6 of polypropylene is stacked in the feeding station 1, is removed individually from below out of the stack and is then conveyed to the timed conveying unit for filling the envelope at position 2. One cycle after filling at position 3, a pressurized supply nozzle 7 is placed onto the rear surface of the envelope 6 for continuously supplying a quantity of adhesive as predetermined by a control device, wherein the adhesive can be activated by light radiation. During the subsequent cycle, the envelope flap is closed and the envelope travels in the next following cycle 5 through an intensive light radiation which spontaneously activates the adhesive and effects the glued connection. The reaction time is so short that a secure glued connection is ensured even in critical speed ranges of processing.

In accordance with an advantageous feature, the supply nozzle 7 supplies an adhesive which is curable by UV-radiation. In that case, the device 9 emits an appropriate UV-light.

While specific embodiments of the invention have been shown and described in detail to illustrate the inventive principles, it will be understood that the invention may be embodied otherwise without departing from such principles.

I claim:

1. An apparatus for sealing envelopes of plastics material, particularly polypropylene, the apparatus comprising,
a gluing station for applying, after each envelope has been filled, an adhesive which can be activated or cured by light radiation onto at least one surface of the envelope to be glued, and
following the gluing station in a conveying direction of the envelopes, a device for light radiation of the adhesive applied to the envelope.

2. The apparatus according to claim 1, wherein the adhesive is curable by UV-radiation, and wherein the device for light radiation is configured to emit UV-radiation.
